(19) United States
(12) Patent Application Publication
(10) Pub. No.: US 2026/0268167 A1
(43) Pub. Date: Sep. 10, 2026

(54) SOLUTION DEVICE, SOLUTION METHOD, AND SOLUTION PROGRAM

(71) Applicant: NEC Corporation, Minato-ku, Tokyo (JP)

(72) Inventor: Fumiyo TAKANO, Tokyo (JP)

(73) Assignee: NEC Corporation, Minato-ku, Tokyo (JP)

(21) Appl. No.: 18/876,206

(22) PCT Filed: Jun. 23, 2022
(86) PCT No.: PCT/JP2022/025053

§ 371 Date: Dec. 18, 2024

(51) Int. Cl. G06N 5/01

(52) U.S. Cl. CPC G06N 5/01

(57) ABSTRACT

The neighboring state generation means 71 finds a neighboring state of a current state and deems that the current state transitioned to the state, and then repeats a process of finding a neighboring state of the state deemed transitioned, and deeming that it transitioned to the neighboring state of the state deemed transitioned. The best state selection means 73 selects a state with maximum or minimum evaluation value corresponding to a state as a best state from among the individual states deemed transitioned. The transition determination means 74 determines whether or not the current state transitions to the best state. The state transition means 75 transitions the current state to the best state when it is determined that the current state transitions to the best state.

### TECHNICAL FIELD

The present invention relates to a solution device, a solution method, and a solution program that find a solution of a combinatorial optimization problem.

### BACKGROUND ART

The simulated annealing is sometimes used to find a solution of a combinatorial optimization problem. In the simulated annealing, a state with the maximum or minimum evaluation value is found, and the state is used as the solution. In this case, an evaluation value function is given to find the evaluation value. Whether to find the state with the maximum evaluation value or the state with the minimum evaluation value depends on the combinatorial optimization problem.

The Ising model or QUBO (Quadratic Unconstrained Binary Optimization) may also be used to find a solution of a combinatorial optimization problem using the simulated annealing. In this case, the energy of the Ising model or QUBO corresponds to the above evaluation value, and the energy function of the Ising model or QUBO corresponds to the above evaluation value function. In this description, to unify the wording, the energy of the Ising model or QUBO is referred to as the evaluation value when the Ising model or QUBO is used. The energy function of the Ising model or QUBO is also referred to as the evaluation value function. However, when the simulated annealing is performed using the Ising model or QUBO, the state in which the evaluation value (the energy) is the minimum is found as the solution.

The Ising model is a statistical mechanics model that represents the behavior of a magnetic material by individual spins, but it is also applicable to solving a combinatorial optimization problem. In the Ising model, the values of the individual spins are represented by “1” or “−1”.

The evaluation value function (the energy function) of the Ising model is expressed as in Expression (1) below.

$$\begin{matrix}[ Math . 1 ] & \\ E = {\sum }_{ij} {J}_{ij} {s}_{i} {s}_{j} + {\sum }_{i} {h}_{i} {s}_{i} & ( 1 )\end{matrix}$$

Both i and j in Expression (1) are variables representing spins. Also, sᵢ in Expression (1) is a variable representing the value of spin i, and sⱼ is a variable representing the value of spin j. The values of spins i and j are either binary values of “1” or “−1”, respectively. hᵢ in Expression (1) is a constant corresponding to spin i. For each possible value of i, hi is determined as a constant. Jᵢⱼ in Expression (1) is a constant corresponding to the combination of spin i and spin j. For each combination of possible value of i and possible value of j, Jᵢⱼ is determined as a constant.

QUBO is a model in which the values of the individual spins are represented as “1” or “0”.

The evaluation value function (the energy function) of QUBO is expressed as in Expression (2) below.

$$\begin{matrix}[ Math . 2 ] & \\ E = {\sum }_{ij} {Q}_{ij} {s}_{i} {s}_{j} & ( 2 )\end{matrix}$$

Both i and j in Expression (2) are variables representing spins. Also, sᵢ in Expression (2) is a variable representing the value of spin i, and sⱼ is a variable representing the value of spin j. The values of spins i and j are either binary values of “1” or “0”, respectively. Qᵢⱼ in Expression (2) is a constant corresponding to the combination of spin i and spin j. For each combination of possible value of i and possible value of j, Qᵢⱼ is determined as a constant.

The evaluation value function (the energy function) of the Ising model or QUBO is input to a solution device that performs the simulated annealing. The solution device finds the state of each spin that corresponds to a solution of a combinatorial optimization problem by the simulated annealing.

PTL 1 describes the simulated annealing that does not use the Ising model or QUBO. However, the term “energy” or “energy function” is used in PTL 1. In the technique described in PTL 1, the values of the energy function of the state variable X+ΔXᵢ are obtained while incrementing the subscript i. In the technique described in PTL 1, the state variable X+ΔXᵢ with the minimum energy value is selected, and a transition determination is made with respect to that state variable.

In other words, the technique described in PTL 1 finds multiple states that can transition from the current state respectively, and then determines whether or not to make the transition with respect to the state with the minimum energy among them.

In addition, PTL 2 describes that when a spin is selected, if the group to which the spin belongs satisfies a predetermined constraint regarding the group and it is determined to change the value of the spin, the values of one or more spins including that spin are changed so that the group maintains a state in which the group satisfies the constraint.

### CITATION LIST

### Patent Literature

PTL 1: Japanese Patent Application Laid-Open No. H7-200517
PTL 2: International Publication WO2021/059338

### SUMMARY OF INVENTION

### Technical Problem

As described above, the technique described in PTL 1 finds multiple states that can transition from the current state respectively, and then determines whether or not to make the transition with respect to the state with the minimum energy among them. FIG. 8 is a schematic diagram showing an example of the current state and multiple states that can transition from the current state when QUBO is applied to the technique described in PTL 1. In the example shown in FIG. 8, there are four spins. It is assumed that a constraint that “Only one spin has a value of 1, and all other spins have values of 0.” is defined for the four spins. This constraint is hereafter referred to as the one-hot constraint. FIG. 8 shows the case where the current state satisfies the one-hot constraint to simplify the explanation. When QUBO is applied to the technique described in PTL 1, as shown in FIG. 8, multiple states that can transition from the current state are found, and the state with the minimum evaluation value (the energy) is selected from among the multiple states. It is determined whether or not to transition from the current state to the selected state. However, in the example shown in FIG. 8, none of the states that can transition from the current state satisfy the one-hot constraint, and the evaluation value of each state is greater than the current evaluation value. Therefore, it is difficult to transition from one local solution to another local solution, and as a result, the derivation of the optimal solution takes time.

FIG. 9 is a schematic diagram showing an example of the current state and the next state that can transition from that state in the technique described in PTL 2. In this example, it is assumed that there are 16 spins arranged in 4 rows and 4 columns. It is assumed that each row and each column have the one-hot constraint. Furthermore, it is assumed that, in the current state, all rows and all columns satisfy the one-hot constraint (see FIG. 9). It is assumed that a spin at the first row, the first column in the current state is selected and the value of the spin is changed from “1” to “0”. In this case, for example, the spin at the first row, the third column is also changed from “0” to “1” so that the group of spins in the first row to which the spin belongs remains in a state that satisfies the one-hot constraint. In this case, by changing the values of the two spins in the first row, the one-hot constraint is kept satisfied for the group of spins in the first row. However, the one-hot constraint is no longer satisfied for the group of spins in the first column and the group of spins in the third column. Therefore, the evaluation value of the next state of the current state is greater than the evaluation value of the current state. Therefore, it is difficult to transition from one local solution to another local solution, and as a result, the derivation of the optimal solution takes time.

Therefore, the purpose of the present invention is to provide a solution device, a solution method and a solution program that can find an optimal solution to a combinatorial optimization problem at high speed.

### Solution to Problem

A solution device according to the present invention is a solution device that finds a state corresponding to a solution of a combinatorial optimization problem by executing simulated annealing, including: neighboring state generation means which finds a neighboring state of a current state and deems that the current state transitioned to the state, and then repeats a process of finding a neighboring state of the state deemed transitioned, and deeming that it transitioned to the neighboring state of the state deemed transitioned; best state selection means which selects a state with maximum or minimum evaluation value corresponding to a state as a best state from among the individual states deemed transitioned; transition determination means which determines whether or not the current state transitions to the best state; and state transition means which transitions the current state to the best state when it is determined that the current state transitions to the best state.

A solution method according to the present invention is a solution method for finding a state corresponding to a solution of a combinatorial optimization problem by executing simulated annealing, implemented by a computer, including: a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned; a best state selection process of selecting a state with maximum or minimum evaluation value corresponding to a state as a best state from among the individual states deemed transitioned; a transition determination process of determining whether or not the current state transitions to the best state; and a state transition process of transitioning the current state to the best state when it is determined that the current state transitions to the best state.

A solution program according to the present invention is a solution program for finding a state corresponding to a solution of a combinatorial optimization problem by executing simulated annealing, wherein the solution program causes a computer to execute: a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned; a best state selection process of selecting a state with maximum or minimum evaluation value corresponding to a state as a best state from among the individual states deemed transitioned; a transition determination process of determining whether or not the current state transitions to the best state; and a state transition process of transitioning the current state to the best state when it is determined that the current state transitions to the best state. The present invention may also be a computer-readable recording medium in which the solution program described above is recorded.

### Advantageous Effects of Invention

According to the present invention, it is possible to find an optimal solution to a combinatorial optimization problem at high speed.

### BRIEF DESCRIPTION OF DRAWINGS

FIG. 1 It depicts a block diagram showing a configuration example of a solution device of the first example embodiment of the present invention.

FIG. 2 It depicts a schematic diagram showing an example of the current state and multiple neighboring states obtained in a chain.

FIG. 3 It depicts a schematic diagram showing another example of the current state and multiple neighboring states obtained in a chain.

FIG. 4 It depicts a flowchart showing an example of the processing flow of the first example embodiment of the present invention.

FIG. 5 It depicts a schematic diagram showing an example of the current state, and multiple neighboring states obtained in a chain in the second example embodiment.

FIG. 6 It depicts a schematic block diagram showing an example of a computer configuration of the solution device of each of the example embodiments of the present invention.

FIG. 7 It depicts a block diagram showing an overview of the solution device of the present invention.

FIG. 8 It depicts a schematic diagram showing an example of the current state and multiple states that can transition from the current state when QUBO is applied to the technique described in PTL 1.

FIG. 9 It depicts a schematic diagram showing an example of the current state and the next state that can transition from that state in the technique described in PTL 2.

### DESCRIPTION OF EMBODIMENTS

Example embodiments of the present invention are described below with reference to the drawings.

In the following, an example in which QUBO is applied to the simulated annealing is described. In this case, the evaluation value function (the energy function) of QUBO is input to the solution device of the present invention. The solution device of the present invention finds a state corresponding to a solution of a combinatorial optimization problem by executing the simulated annealing.

### Example Embodiment 1

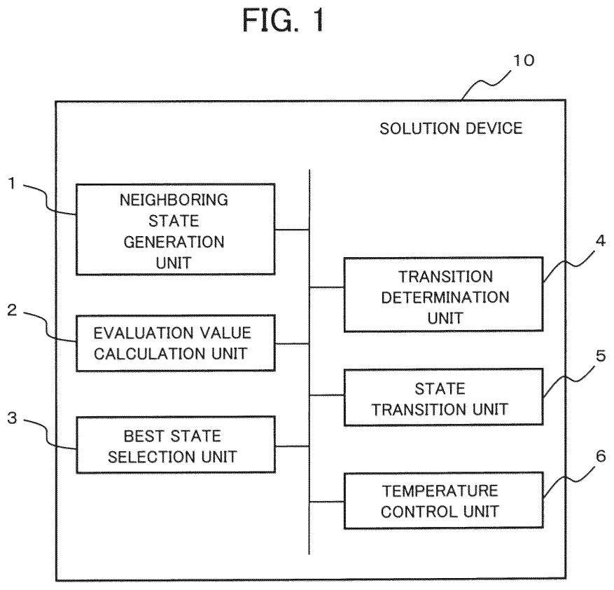

FIG. 1 is a block diagram showing a configuration example of a solution device of the first example embodiment of the present invention. The solution device 10 of the first example embodiment includes a neighboring state generation unit 1, an evaluation value calculation unit 2, a best state selection unit 3, a transition determination unit 4, a state transition unit 5, and a temperature control unit 6.

The neighboring state generation unit 1 finds a neighboring state of a current state and deems that the current state transitioned to the neighboring state. Thereafter, the neighboring state generation unit 1 repeats the process of finding a neighboring state of the state deemed transitioned, and deeming that it transitioned to the neighboring state of the state deemed transitioned.

More specifically, the neighboring state generation unit 1 finds a neighboring state of the current state by changing some of spin values from the current state, and deems that the current state transitioned to the neighboring state. Thereafter, the neighboring state generation unit 1 repeats the process of finding a neighboring state of the state deemed transitioned by changing some of spin values from the state deemed transitioned, and deeming that it transitioned to the neighboring state of the state deemed transitioned.

A state where some part of the previous state has been changed is denoted as a neighboring state of the previous state. Each individual state that is deemed transitioned is a neighboring state of the previous state.

In the present example embodiment, it is assumed that the number of times to repeat the process of finding a neighboring state of the state deemed transitioned, and deeming that it transitioned to the neighboring state of the state deemed transitioned is a fixed value. Thus, in the present example embodiment, the first to the predetermined number of neighboring states are obtained. The neighboring state generation unit 1 finds each neighboring state from the first to the predetermined number in a chain.

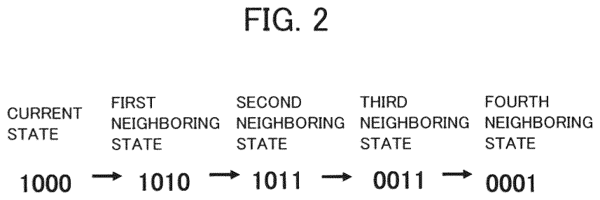

FIG. 2 is a schematic diagram showing an example of the current state and multiple neighboring states obtained in a chain. In FIG. 2, the case in which the state is represented by four spins is illustrated. It is assumed that the state represented by the four spins has a one-hot constraint.

In this example, the neighboring state generation unit 1 changes a value of one spin when finding a neighboring state of a state. The neighboring state generation unit 1 may randomly select a spin whose value is changed. In this example, the neighboring state generation unit 1 finds each neighboring state from the first to the fourth in a chain (see FIG. 2).

In the example shown in FIG. 2, the case in which the current state satisfies the one-hot constraint is illustrated, but the current state need not satisfy the one-hot constraint.

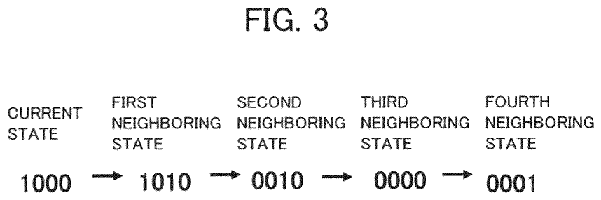

The neighboring state generation unit 1 may also select one spin whose value is changed to satisfy a defined constraint (in this example, the one-hot constraint) as much as possible. In this case, in the process of finding the last neighboring state (in this example, the fourth neighboring state), it may be deemed that it transitioned from a neighboring state where the constraint is satisfied to a neighboring state where the constraint is not satisfied. FIG. 3 is a schematic diagram showing another example of the current state and multiple neighboring states obtained in a chain. In the example shown in FIG. 3, a neighboring state that satisfies the one-hot constraint is obtained as the second neighboring state. In the third neighboring state, the one-hot constraint is no longer satisfied.

FIG. 2 shows the case where the neighboring state (the fourth neighboring state) that satisfies the one-hot constraint is obtained. FIG. 3 also shows the case where the neighboring states (the second and the fourth neighboring states) that satisfy the one-hot constraint are obtained. However, any neighboring state may not satisfy the defined constraint.

The evaluation value calculation unit 2 calculates the evaluation value (the energy) corresponding to the neighboring state for each individual neighboring state (the individual states deemed transitioned). The evaluation value calculation unit 2 can calculate the evaluation value by substituting the value of each spin in the neighboring state into the given QUBO evaluation value function (the energy function).

The best state selection unit 3 selects the neighboring state with the minimum evaluation value corresponding to the neighboring state as the best state from among the individual neighboring states (the individual states deemed transitioned). In the example shown in FIG. 2, the fourth neighboring state satisfies the one-hot constraint. Therefore, the energy of the fourth neighboring state is considered to be the minimum among the four neighboring states shown in FIG. 2. Therefore, in this example, the energy of the fourth neighboring state is assumed to be the minimum. In this case, the best state selection unit 3 selects the fourth neighboring state shown in FIG. 2 as the best state. Even if none of the neighboring states satisfy the one-hot constraint, the best state selection unit 3 selects the neighboring state with the minimum evaluation value corresponding to the neighboring state as the best state from among the individual neighboring states.

The transition determination unit 4 determines whether or not the current state (see FIG. 2) transitions to the best state selected by the best state selection unit 3. The transition determination unit 4 calculates a transition probability based on the difference between the evaluation value of the current state and the evaluation value of the best state and a temperature in the simulated annealing. Then, the transition determination unit 4 determines whether or not the current state transitions to the best state based on the transition probability.

The state transition unit 5 transitions the current state to the best state when it is determined that the current state transitions to the best state. This operation changes the current state.

The temperature control unit 6 changes the temperature in the simulated annealing according to the number of loop processes in the simulated annealing. More specifically, the temperature control unit 6 decreases the temperature as the number of loop processes in the simulated annealing increases.

The neighboring state generation unit 1, the evaluation value calculation unit 2, the best state selection unit 3, the transition determination unit 4, the state transition unit 5, and the temperature control unit 6 are realized, for example, by a CPU (Central Processing Unit) of a computer operating according to a solution program. For example, the CPU may read the solution program from a program storage medium such as a program storage device of the computer and operate as the neighboring state generation unit 1, the evaluation value calculation unit 2, the best state selection unit 3, the transition determination unit 4, the state transition unit 5, and the temperature control unit 6 according to the solution program.

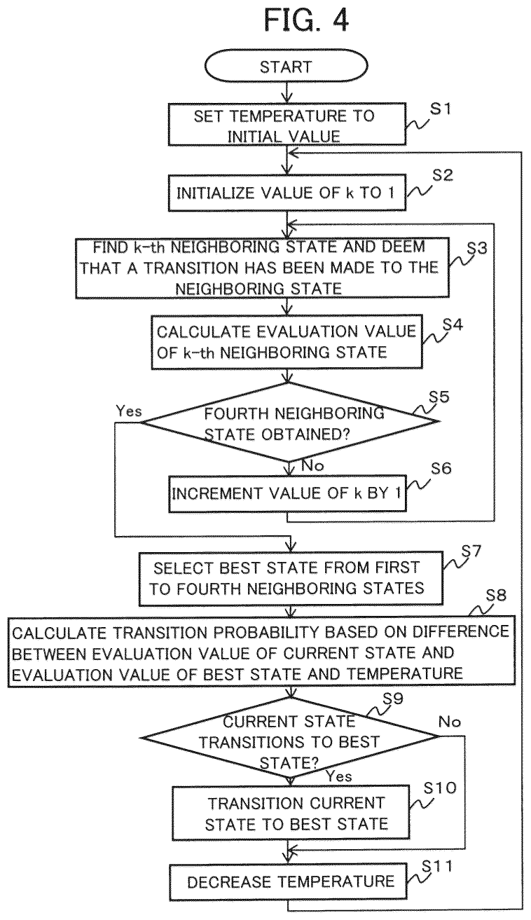

Next, the processing flow is described. FIG. 4 is a flowchart showing an example of the processing flow of the present example embodiment. Detailed explanations of matters already explained are omitted. It is assumed that the evaluation value function (the energy function) of QUBO has been input into the solution device 10 in advance. In this example, as in the case illustrated in FIG. 2, the case of finding the first through fourth neighboring states is used as an example, but the last neighboring state is not limited to the fourth neighboring state.

First, the temperature control unit 6 sets the temperature in the simulated annealing to the initial value (step S1).

Next, the neighboring state generation unit 1 initializes the value of k to 1 (step S2). k is a variable indicating the number of neighboring states to be generated.

Next, the neighboring state generation unit 1 finds the k-th neighboring state and deems that a transition has been made to the neighboring state (step S3). When step S3 is first executed, k=1. Therefore, the neighboring state generation unit 1 finds the neighboring state of the current state (the first neighboring state) by changing some of spin values from the current state, and deems that the current state transitioned to the neighboring state.

Next, the evaluation value calculation unit 2 calculates the evaluation value of the k-th neighboring state obtained in the most recent step S3 (step S4).

Then, the neighboring state generation unit 1 determines whether or not the fourth neighboring state has been obtained (step S5).

When the fourth neighboring state has not been obtained (No in step S5), the neighboring state generation unit 1 increments the value of k by 1 (step S6).

After step S6, processing from step S3 onward is repeated. In the second or subsequent processing of step S3, by changing some of spin values from the k−1st neighboring state, the neighboring state generation unit 1 finds the neighboring state of “the k−1st neighboring state” (k-th neighboring state) and deems that a transition has been made to the neighboring state.

When the fourth neighboring state has been obtained (step S5, Yes), the best state selection unit 3 selects the best state from the first to the fourth neighboring states (step S7). In other words, the best state selection unit 3 selects a neighboring state with the minimum evaluation value as the best state from the first to the fourth neighboring states.

Next to step S7, the transition determination unit 4 calculates the transition probability based on the difference between the evaluation value of the current state and the evaluation value of the best state selected in step S7 and the temperature in the simulated annealing (step S8). Then, the transition determination unit 4 determines whether or not the current state transitions to the best state based on the transition probability (step S9).

When it is determined that the current state transitions to the best state (Yes in step S9), the state transition unit 5 transitions the current state to the best state (step S10). Step S10 causes the current state to change.

After step S10, the process moves to step S11. When it is determined that the current state does not transition to the best state (No in step S9), then step S10 is not performed and the process moves to step S11.

In step S11, the temperature control unit 6 decreases the temperature in the simulated annealing by a predetermined value.

The loop process of steps S2 to S11 is the loop process in the simulated annealing. For example, the state obtained when this loop process is executed a predetermined number of times may be the state corresponding to the solution of the combinatorial optimization problem.

In the present example embodiment, the neighboring state generation unit 1 finds a neighboring state of the current state, and deems that the current state transitioned to the neighboring state. Thereafter, the neighboring state generation unit 1 repeats the process of finding a neighboring state of the state deemed transitioned, and deeming that it transitioned to the neighboring state of the state deemed transitioned. That is, the neighboring state generation unit 1 uses the current state as a starting point to find neighboring states in a chain. Then, the best state selection unit 3 selects the best state from the obtained individual neighboring states. Then, the transition determination unit 4 determines whether or not the current state transitions to the best state, and when it is determined that the current state transitions to the best state, the state transition unit 5 transitions the current state to the best state. Therefore, the best state is selected not only from the neighboring state of the current state, but also from among multiple neighboring states obtained in a chain starting from the current state. Therefore, in the present example embodiment, it is easy to transition a local solution to another local solution, and an optimal solution to a combinatorial optimization problem can be found at high speed.

### Example Embodiment 2

An example of the configuration of the solution device of the second example embodiment of the present invention can be represented as in FIG. 1. Therefore, the second example embodiment is explained with reference to FIG. 1. The second example embodiment is also be explained using the case where QUBO is applied. The same matters as in the first example embodiment are omitted from the explanation.

The second example embodiment is an example embodiment to which technique similar to PTL 2 is applied.

In the present example embodiment is explained using an example in which spin values are arranged in 4 rows and 4 columns. It is assumed that each group of spins in each row has a predetermined one-hot constraint. Similarly, it is assumed that each group of spins in each column has a predetermined one-hot constraint. That is, it is assumed that the eight groups of spins have the one-hot constraint.

As in the first example embodiment, the neighboring state generation unit 1 finds a neighboring state of the current state by changing some of spin values from the current state, and deems that the current state transitioned to the neighboring state. Thereafter, the neighboring state generation unit 1 repeats the process of finding a neighboring state of the state deemed transitioned by changing some of spin values from the state deemed transitioned, and deeming that it transitioned to the neighboring state of the state deemed transitioned. As in the first example embodiment, it is assumed that the number of times to repeat the process of finding a neighboring state of the state deemed transitioned, and deeming that it transitioned to the neighboring state of the state deemed transitioned is a fixed value. Thus, the first to the predetermined number of neighboring states are obtained.

However, when finding a neighboring state, the neighboring state generation unit 1 selects a spin and selects a group to which the spin belongs. When there are multiple groups to which the selected spin belongs, the neighboring state generation unit 1 selects one group from the multiple groups. When the selected group satisfies the predetermined constraint, the neighboring state generation unit 1 changes the values of one or more spins including the selected spin so that the group maintains the state in which the constraint is satisfied.

If there is a group of spins for which the constraint is not satisfied when finding a neighboring state, the neighboring state generation unit 1 selects a spin and changes the value of that spin so that the group approaches the state that satisfies the constraint.

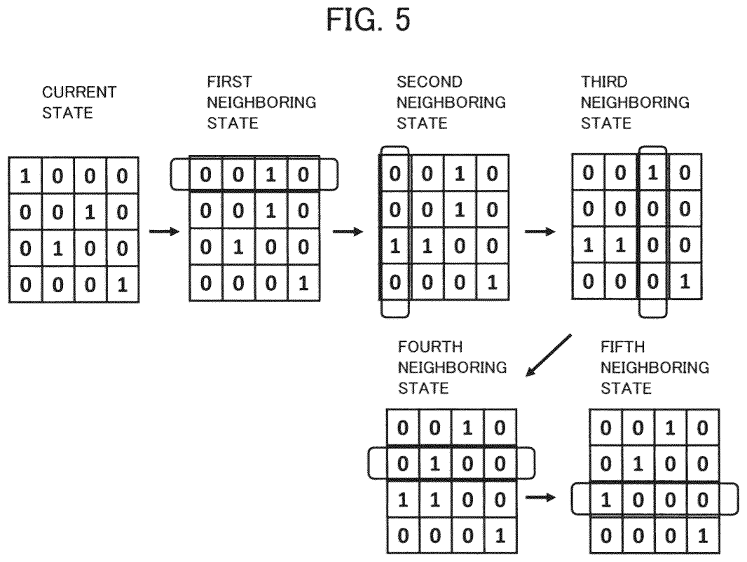

FIG. 5 is a schematic diagram showing an example of the current state, and multiple neighboring states obtained in a chain in the second example embodiment. The example shown in FIG. 5 illustrates the case where the current state satisfies all constraints (eight one-hot constraints), but some or all of the one-hot constraints may not be satisfied in the current state. FIG. 5 also shows the case where the first to the fifth neighboring states are obtained. However, there is no particular limit to the number of neighboring states that is obtained.

It is assumed that when finding the neighboring state of the current state (the first neighboring state), the neighboring state generation unit 1 selects a spin at the first row, the first column, and selects the group of spins in the first row as the group to which the spin belongs. Since the group of spins in the first row satisfies the one-hot constraint, the neighboring state generation unit 1 changes the value of the spin at the first row, the first column and the value of the spin at the first row, the third column, respectively, to keep the group of spins in the first row satisfying the one-hot constraint. As a result, the neighboring state generation unit 1 obtains the first neighboring state and deems that the current state transitioned to that neighboring state (see FIG. 5).

In the first neighboring state, the group of spins in the first column is in a state where the one-hot constraint is not satisfied. The neighboring state generation unit 1 selects a spin at the third row, the first column, for example, and changes the value of that spin so that the group of spins in the first column approaches the state where the one-hot constraint is satisfied. As a result, the neighboring state generation unit 1 obtains the second neighboring state and deems that the first neighboring state transitioned to that neighboring state (see FIG. 5).

In the second neighboring state, the group of spins in the third column is in a state where the one-hot constraint is not satisfied. The neighboring state generation unit 1 selects a spin at the second row, the third column, for example, and changes the value of that spin so that the group of spins in the third column approaches the state where the one-hot constraint is satisfied. As a result, the neighboring state generation unit 1 obtains the third neighboring state and deems that the second neighboring state transitioned to that neighboring state (see FIG. 5).

In the third neighboring state, the group of spins in the second row is in a state where the one-hot constraint is not satisfied. The neighboring state generation unit 1 selects a spin at the second row, the second column, for example, and changes the value of that spin so that the group of spins in the second row approaches the state where the one-hot constraint is satisfied. As a result, the neighboring state generation unit 1 obtains the fourth neighboring state and deems that the third neighboring state transitioned to that neighboring state (see FIG. 5).

In the fourth neighboring state, the group of spins in the second column is in a state where the one-hot constraint is not satisfied. The neighboring state generation unit 1 selects a spin at the third row, the second column, for example, and changes the value of that spin so that the group of spins in the second column approaches the state where the one-hot constraint is satisfied. As a result, the neighboring state generation unit 1 obtains the fifth neighboring state and deems that the fourth neighboring state transitioned to that neighboring state (see FIG. 5).

In the fifth neighboring state, all constraints (8 one-hot constraints) are satisfied. However, the first through fifth neighboring states do not have to include a neighboring state that satisfies all constraints.

Also, as in this example, it is assumed that when there are multiple constraints, the neighboring state generation unit 1 finds the neighboring state. In this case, the neighboring state generation unit 1 may select the spin whose value is changed so that the number of satisfied constraints increases the most.

In the process of finding the last neighboring state (in this example, the fifth neighboring state), it may be possible to deem a neighboring state in which all constraints are satisfied transitions to a neighboring state in which the constraints are not satisfied in at least some groups.

The operations of the evaluation value calculation unit 2, the best state selection unit 3, the transition determination unit 4, the state transition unit 5, and the temperature control unit 6 are the same as those of the evaluation value calculation unit 2, the best state selection unit 3, the transition determination unit 4, the state transition unit 5, and the temperature control unit 6 in the first example embodiment, and the explanation is omitted.

In the second example embodiment, the best state is selected from among multiple neighboring states obtained in a chain starting from the current state. Therefore, in the present example embodiment, it is easy to transition a local solution to another local solution, and an optimal solution to a combinatorial optimization problem can be found at high speed.

Next, variations of each of the example embodiments of the present invention are explained.

In the first example embodiment and the second example embodiment, the case where QUBO is applied is shown, but the Ising model may also be applied. In this case, the evaluation value function (the energy function) of the Ising model is input to the solution device 10 of the present invention. Then, the evaluation value calculation unit 2 may use that evaluation value function to calculate the evaluation value corresponding to a neighboring state for each of the individual neighboring states.

In the first example embodiment and the second example embodiment, the QUBO or the Ising model may not be applied. In this case, an evaluation value function other than the QUBO or the Ising model energy function is input to the solution device 10 of the present invention. When QUBO or the Ising model is not applied, in the simulated annealing, the state with the maximum or minimum evaluation value is found as an optimal solution. As described above, whether to find the state with the maximum evaluation value or the state with the minimum evaluation value depends on the combinatorial optimization problem.

When the state with the maximum evaluation value is to be found, the best state selection unit 3 selects, as the best state, the neighboring state with the maximum evaluation value corresponding to the neighboring state from among the individual neighboring states (individual states deemed transitioned).

When the state with the minimum evaluation value is to be found, the best state selection unit 3 selects, as the best state, the neighboring state with the minimum evaluation value corresponding to the neighboring state from among the individual neighboring states (individual states deemed transitioned).

In the first example embodiment and the second example embodiment, the case where the number of times to repeat the process of finding a neighboring state of the state deemed transitioned, and deeming that it transitioned to the neighboring state of the state deemed transitioned (hereinafter referred to as “the repeat count”) is the fixed value was used as an example. In the process of the simulated annealing, the neighboring state generation unit 1 may change the repeat count. In other words, the neighboring state generation unit 1 may change how many neighboring states are found from the first neighboring state in the process of the simulated annealing.

For example, the neighboring state generation unit 1 may change the repeat count based on the temperature in the simulated annealing. For example, the neighboring state generation unit 1 may increase the repeat count when the temperature in the simulated annealing falls below a threshold value (a threshold value compared to the temperature).

For example, the neighboring state generation unit 1 may change the repeat count based on the number of loop processes in the simulated annealing (e.g., the loop processes in steps S2 to S11 shown in FIG. 4). For example, the neighboring state generation unit 1 may increase the repeat count when the number of loop processes exceeds a threshold value (a threshold value compared to the number of loop processes).

For example, the neighboring state generation unit 1 may change the repeat count based on the ratio of the number of times it is determined to make a transition from the current state to the best state (e.g., the number of times of the transition from step S9 to step S10) to the number of determinations by the transition determination unit 4 (e.g., the number of determinations in step S9) (hereinafter, referred to as the acceptance ratio). For example, the neighboring state generation unit 1 may increase the repeat count when the acceptance ratio is below a threshold value (a threshold value compared to the acceptance ratio).

In the first example embodiment, the neighboring state generation unit 1 may continue the repeat process of finding a neighboring state of the state deemed transitioned, and deeming that it transitioned to the neighboring state of the state deemed transitioned until the neighboring state generation unit 1 deems that it transitioned to a neighboring state in which the constraint is satisfied.

In the second example embodiment, the neighboring state generation unit 1 may continue the repeat process of finding a neighboring state of the state deemed transitioned, and deeming that it transitioned to the neighboring state of the state deemed transitioned until the neighboring state generation unit 1 deems that it transitioned to a neighboring state in which all multiple constraints are satisfied.

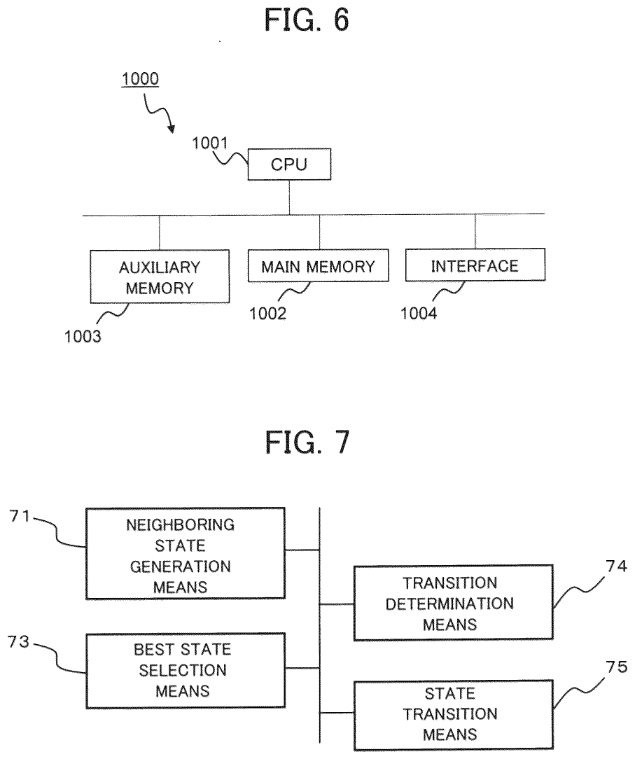

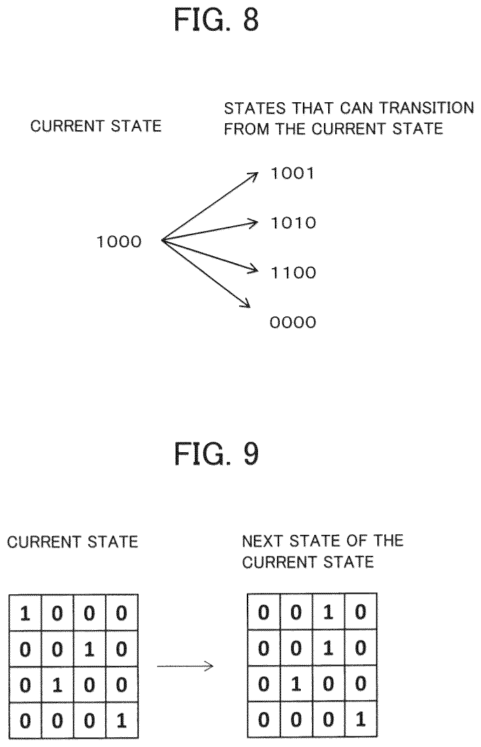

FIG. 6 is a schematic block diagram showing an example of a computer configuration of the solution device 10 of each of the example embodiments of the present invention. The computer 1000 includes a CPU 1001, a main memory 1002, an auxiliary memory 1003, and an interface 1004.

The solution device 10 of each example embodiment of the present invention is realized by the computer 1000. The operation of the solution device 10 is stored in the auxiliary memory 1003 in the form of a solution program. The CPU 1001 reads the solution program from the auxiliary memory 1003, expands the solution program into the main memory 1002, and executes the processes described in each of the above example embodiments according to the solution program.

The auxiliary memory 1003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 1004. When the program is delivered to the computer 1000 through a communication line, the computer 1000 receiving the delivery may expand the program into the main memory 1002 and execute the processes described in each of the above example embodiments according to the program.

Some or all of the components may be realized by general-purpose or dedicated circuitry, processor, or a combination of these. These may comprise a single chip or multiple chips connected via a bus. Some or all of each component may be realized by a combination of the above-mentioned circuitry, etc. and a program.

When some or all of each component are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

The following is an overview of the present invention. FIG. 7 is a block diagram showing an overview of the solution device of the present invention. The solution device of the present invention includes neighboring state generation means 71, best state selection means 73, transition determination means 74, and state transition means 75.

The neighboring state generation means 71 (e.g., the neighboring state generation unit 1) finds a neighboring state of a current state and deems that the current state transitioned to the state, and then repeats a process of finding a neighboring state of the state deemed transitioned, and deeming that it transitioned to the neighboring state of the state deemed transitioned.

The best state selection means 73 (e.g., the best state selection unit 3) selects a state with maximum or minimum evaluation value corresponding to a state as a best state from among the individual states deemed transitioned.

The transition determination means 74 (e.g., the transition determination unit 4) determines whether or not the current state transitions to the best state.

The state transition means 75 (e.g., the state transition unit 5) transitions the current state to the best state when it is determined that the current state transitions to the best state.

With such a configuration, it is possible to find an optimal solution to a combinatorial optimization problem at high speed.

Each of the above example embodiments of the present invention and its variations may also be described as, but is not limited to, the following supplementary notes.

(Supplementary note 1) A solution device that finds a state corresponding to a solution of a combinatorial optimization problem by executing simulated annealing, comprising:
neighboring state generation means which finds a neighboring state of a current state and deems that the current state transitioned to the state, and then repeats a process of finding a neighboring state of the state deemed transitioned, and deeming that it transitioned to the neighboring state of the state deemed transitioned;
best state selection means which selects a state with maximum or minimum evaluation value corresponding to a state as a best state from among the individual states deemed transitioned;
transition determination means which determines whether or not the current state transitions to the best state; and
state transition means which transitions the current state to the best state when it is determined that the current state transitions to the best state.

(Supplementary note 2) The solution device according to supplementary note 1, wherein
the evaluation value of the Ising model or the evaluation value of QUBO (Quadratic Unconstrained Binary Optimization) is used, and
the best state selection means selects a state with the minimum evaluation value corresponding to a state as the best state from among the individual states deemed transitioned.

(Supplementary note 3) The solution device according to supplementary note 2, wherein
the neighboring state generation means finds the neighboring state of the current state by changing some of spin values from the current state, deems that the current state transitioned to the state, and then repeats the process of finding the neighboring state of the state deemed transitioned by changing some of spin values from the state deemed transitioned, and deeming that it transitioned to the neighboring state of the state deemed transitioned.

(Supplementary note 4) The solution device according to supplementary note 3, wherein
when finding the neighboring state, the neighboring state generation means selects a spin, and selects a group to which the spin belongs,
when the group satisfies a predetermined constraint, the neighboring state generation means changes values of one or more spins including the spin, so that the group maintains a state in which the constraint is satisfied.

(Supplementary note 5) The solution device according to supplementary note 4, wherein
if there is a group of spins for which the constraint is not satisfied when finding the neighboring state, the neighboring state generation means selects a spin and changes the value of the spin so that the group approaches a state that satisfies the constraint.

(Supplementary note 6) The solution device according to any one of supplementary notes 1 to 5, wherein
the neighboring state generation means changes the number of times to repeat the process of finding a neighboring state of the state deemed transitioned, and deeming that it transitioned to the neighboring state of the state deemed transitioned, based on temperature in the simulated annealing.

(Supplementary note 7) The solution device according to any one of supplementary notes 1 to 5, wherein
the neighboring state generation means changes the number of times to repeat the process of finding a neighboring state of the state deemed transitioned, and deeming that it transitioned to the neighboring state of the state deemed transitioned, based on the number of loop processes in the simulated annealing.

(Supplementary note 8) The solution device according to any one of supplementary notes 1 to 5, wherein
the neighboring state generation means changes the number of times to repeat the process of finding a neighboring state of the state deemed transitioned, and deeming that it transitioned to the neighboring state of the state deemed transitioned, based on a ratio of the number of times it is determined to make a transition from the current state to the best state to the number of determinations by the transition determination means.

(Supplementary note 9) A solution method for finding a state corresponding to a solution of a combinatorial optimization problem by executing simulated annealing, implemented by a computer, comprising:
a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned;
a best state selection process of selecting a state with maximum or minimum evaluation value corresponding to a state as a best state from among the individual states deemed transitioned;
a transition determination process of determining whether or not the current state transitions to the best state; and
a state transition process of transitioning the current state to the best state when it is determined that the current state transitions to the best state.

(Supplementary note 10) The solution method according to supplementary note 9, wherein
the evaluation value of the Ising model or the evaluation value of QUBO (Quadratic Unconstrained Binary Optimization) is used, and
the computer, in the best state selection process, selects a state with the minimum evaluation value corresponding to a state as the best state from among the individual states deemed transitioned.

(Supplementary note 11) A computer-readable recording medium in which a solution program for finding a state corresponding to a solution of a combinatorial optimization problem by executing simulated annealing is recorded, wherein the solution program causes a computer to execute:
a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned;
a best state selection process of selecting a state with maximum or minimum evaluation value corresponding to a state as a best state from among the individual states deemed transitioned;
a transition determination process of determining whether or not the current state transitions to the best state; and
a state transition process of transitioning the current state to the best state when it is determined that the current state transitions to the best state.

(Supplementary note 12) The computer-readable recording medium in which the solution program is recorded, according to supplementary note 11, wherein
the evaluation value of the Ising model or the evaluation value of QUBO (Quadratic Unconstrained Binary Optimization) is used, and
the solution program causes the computer to execute, in the best state selection process, selecting a state with the minimum evaluation value corresponding to a state as the best state from among the individual states deemed transitioned.

Although the present invention has been described above with reference to the example embodiments, the present invention is not limited to the above example embodiments. Various changes can be made to the configuration and details of the present invention that can be understood by those skilled in the art within the scope of the present invention.

### INDUSTRIAL APPLICABILITY

The present invention is suitably applied to a solution device which finds a solution of a combinatorial optimization problem.

### REFERENCE SIGNS LIST

1 Neighboring state generation unit
2 Evaluation value calculation unit
3 Best state selection unit
4 Transition determination unit
5 State transition unit
6 Temperature control unit
10 Solution device

What is claimed is:

1. A solution device that finds a state corresponding to a solution of a combinatorial optimization problem by executing simulated annealing, comprising:
a memory configured to store instructions; and
a processor configured to execute the instructions to:
find a neighboring state of a current state and deem that the current state transitioned to the state, and then repeat a process of finding a neighboring state of the state deemed transitioned, and deeming that it transitioned to the neighboring state of the state deemed transitioned;
select a state with maximum or minimum evaluation value corresponding to a state as a best state from among the individual states deemed transitioned;
determine whether or not the current state transitions to the best state; and
transition the current state to the best state when it is determined that the current state transitions to the best state.

2. The solution device according to claim 1, wherein
the evaluation value of the Ising model or the evaluation value of QUBO (Quadratic Unconstrained Binary Optimization) is used, and
the processor selects a state with the minimum evaluation value corresponding to a state as the best state from among the individual states deemed transitioned.

3. The solution device according to claim 2, wherein
the processor finds the neighboring state of the current state by changing some of spin values from the current state, deems that the current state transitioned to the state, and then repeats the process of finding the neighboring state of the state deemed transitioned by changing some of spin values from the state deemed transitioned, and deeming that it transitioned to the neighboring state of the state deemed transitioned.

4. The solution device according to claim 3, wherein
when finding the neighboring state, the processor selects a spin, and selects a group to which the spin belongs,
when the group satisfies a predetermined constraint, the processor changes values of one or more spins including the spin, so that the group maintains a state in which the constraint is satisfied.

5. The solution device according to claim 4, wherein
if there is a group of spins for which the constraint is not satisfied when finding the neighboring state, the processor selects a spin and changes the value of the spin so that the group approaches a state that satisfies the constraint.

6. The solution device according to claim 1, wherein
the processor changes the number of times to repeat the process of finding a neighboring state of the state deemed transitioned, and deeming that it transitioned to the neighboring state of the state deemed transitioned, based on temperature in the simulated annealing.

7. The solution device according to claim 1 wherein
the processor changes the number of times to repeat the process of finding a neighboring state of the state deemed transitioned, and deeming that it transitioned to the neighboring state of the state deemed transitioned, based on the number of loop processes in the simulated annealing.

8. The solution device according to claim 1 wherein
the processor changes the number of times to repeat the process of finding a neighboring state of the state deemed transitioned, and deeming that it transitioned to the neighboring state of the state deemed transitioned, based on a ratio of the number of times it is determined to make a transition from the current state to the best state to the number of determinations.

9. A solution method for finding a state corresponding to a solution of a combinatorial optimization problem by executing simulated annealing, implemented by a computer, comprising:
a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned;
a best state selection process of selecting a state with maximum or minimum evaluation value corresponding to a state as a best state from among the individual states deemed transitioned;
a transition determination process of determining whether or not the current state transitions to the best state; and
a state transition process of transitioning the current state to the best state when it is determined that the current state transitions to the best state.

10. The solution method according to claim 9, wherein
the evaluation value of the Ising model or the evaluation value of QUBO (Quadratic Unconstrained Binary Optimization) is used, and
the computer, in the best state selection process, selects a state with the minimum evaluation value corresponding to a state as the best state from among the individual states deemed transitioned.

11. A non-transitory computer-readable recording medium in which a solution program for finding a state corresponding to a solution of a combinatorial optimization problem by executing simulated annealing is recorded, wherein the solution program causes a computer to execute:
a neighboring state generation process of finding a neighboring state of a current state and deeming that the current state transitioned to the state, and then repeating a process of finding a neighboring state of the state deemed transitioned, and deeming that it transitioned to the neighboring state of the state deemed transitioned;
a best state selection process of selecting a state with maximum or minimum evaluation value corresponding to a state as a best state from among the individual states deemed transitioned;
a transition determination process of determining whether or not the current state transitions to the best state; and
a state transition process of transitioning the current state to the best state when it is determined that the current state transitions to the best state.

12. The non-transitory computer-readable recording medium in which the solution program is recorded, according to claim 11, wherein
the evaluation value of the Ising model or the evaluation value of QUBO (Quadratic Unconstrained Binary Optimization) is used, and
the solution program causes the computer to execute, in the best state selection process, selecting a state with the minimum evaluation value corresponding to a state as the best state from among the individual states deemed transitioned.
